(19) United States
(12) Patent Application Publication
(10) Pub. No.: US 2004/0081253 A1
(43) Pub. Date: Apr. 29, 2004

(54) Minimum shift QAM waveform and transmitter

(76) Inventors: Frank Chethik, Palo Alto, CA (US); Edward R. Meyer, Morgan Hill, CA (US)

Correspondence Address: Keith D. Nelson, Lockheed Martin Corporation, Building 220, Mail Stop A08, P.O. Box 49041, San Jose, CA, 95161-9041, US

(21) Appl. No.: 10/278,510

(22) Filed: Oct. 23, 2002

(51) Int. Cl. H04L 27/36; H04L 27/20

(52) U.S. Cl. 375/298; 375/308

(57) ABSTRACT

A minimum shift QAM transmitter and waveform. An exemplary transmitter comprises a local oscillator for generating a reference input signal, a plurality of discrete, parallel quadrature power elements, and a power combiner for combining outputs of each of the quadraphase power elements to produce a multilevel, high-power RF output signal. The plurality of discrete, parallel QPSK power elements each comprise a plurality of data inputs that receive data bits, a plurality of delays that respectively delay each of the individual data bits, a QPSK modulator having an on/off keying (OOK) input for receiving an on/off keying bit input signal that selectively keys the modulator on and off, and a local oscillator input for receiving the reference input signal from the local oscillator, for modulating, and a high-power amplifier driven to saturation that is coupled to the QPSK modulator. The transmitter provides continuous phase and amplitude shifting between QAM states suppresses higher order spectral artifacts and concentrates power in the spectral region close to the reference input (carrier) frequency.

### BACKGROUND

The present invention relates generally to quadrature amplitude modulated (QAM) transmitters, and more particularly, to a minimum shift QAM (MS-QAM) waveform and transmitter.

Traditional “linear” QAM transmitters are generally complex and are relatively power-inefficient. Heretofore, minimum shift keying (MSK) has been used for phase shift keying systems only, and has been in public domain for at least 20 years. The present invention is an extension of minimum shift keying to quadrature amplitude modulated (QAM) systems.

Traditional QAM waveforms provide a multiple state constellation of amplitude-phase states upon which digital n-tuples are mapped. Each of these n-tuples represents an n-bit word (message) that is transmitted in a single QAM symbol.

Referring to the drawing figures, a typical QAM constellation and spectrum are shown in FIGS. 1a and 1b, respectively. Thus the number of symbols per second required to be transmitted is less than the number of bits per second. Since the bandwidth required is 1 to 2 times the rate at which symbols are transmitted, considerable bandwidth efficiency (measured in bits per second transmitted per Hertz of bandwidth required) is achieved with QAM. QAM, however has a number of undesirable characteristics and it is the focus of this invention to modify the basic QAM concept to reduce and minimize these.

The QAM spectrum is mostly confined to a bandpass of a small multiple times the symbol rate. In actuality, 95% of the spectral energy lies within a bandwidth of twice the symbol rate, however, there is significant spectral power that persists at frequencies that are distant from the passband. It is one objective of this invention to reduce this spectral power so that on the order of 95% of the spectrum energy is contained within the symbol rate bandwidth.

It is also an objective of the present invention to provide for a minimum shift QAM waveform and transmitter.

### SUMMARY OF THE INVENTION

To meet the above and other objectives, the present invention comprises a minimum shift QAM (MS-QAM) waveform and transmitter. An exemplary transmitter comprises a local oscillator for generating a reference input signal, a plurality of discrete, parallel Quadrature Phase Shift Keyed (QPSK) power elements, and a power combiner coupled to outputs of each of the QPSK power elements. The power combiner combines the respective output signals from the QPSK power elements to produce a high-power, RF, QAM waveform, output signal.

The number of discrete, parallel QPSK power elements determine the number of data bits that are transmitted. For a standard QAM waveform the QPSK power elements are switched simultaneously once per QAM signaling interval. The present invention switches the QPSK power element one at a time distributed over the entire QAM symbol interval. during the QAM signaling interval. The QPSK power element also comprises a high-power amplifier driven to saturation that is coupled to the respective QPSK modulator.

The present invention enables highly bandwidth efficient data transmission over RF and microwave media and exhibits improved spectral characteristics over traditional QAM signal structures. The present invention provides a step-wise approximation to continuous phase and amplitude shifting between QAM states, thus suppressing higher order spectral artifacts and concentrating power in the spectral region close to the reference input (carrier) frequency. Implementation of the present invention with a modulating array transmitter provides a simple approximation to an ideal minimum shift QAM modulator.

The present invention improves spectrum truncation loss over that incurred by conventional QAM for severely band-limited signals. Implementation with the modulating array transmitter is far less complex and more power-efficient than a traditional “linear” QAM transmitter.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIGS. 1a and 1b show a 64QAM constellation and associated power spectrum, respectively, that illustrates traditional QAM;

FIGS. 2a and 2b show 64MS-QAM trajectories and associated power spectrum, respectively, and illustrates minimum shift QAM (MS-QAM) in accordance with the principles of the present invention;

FIG. 3 illustrates an exemplary seven stage modulating array transmitter that generates 64QAM;

FIG. 4 illustrates an exemplary seven stage modulating array transmitter in accordance with the principles of the present invention;

FIG. 5 illustrates an exemplary complex signal trajectory generated by the present invention;

### DETAILED DESCRIPTION

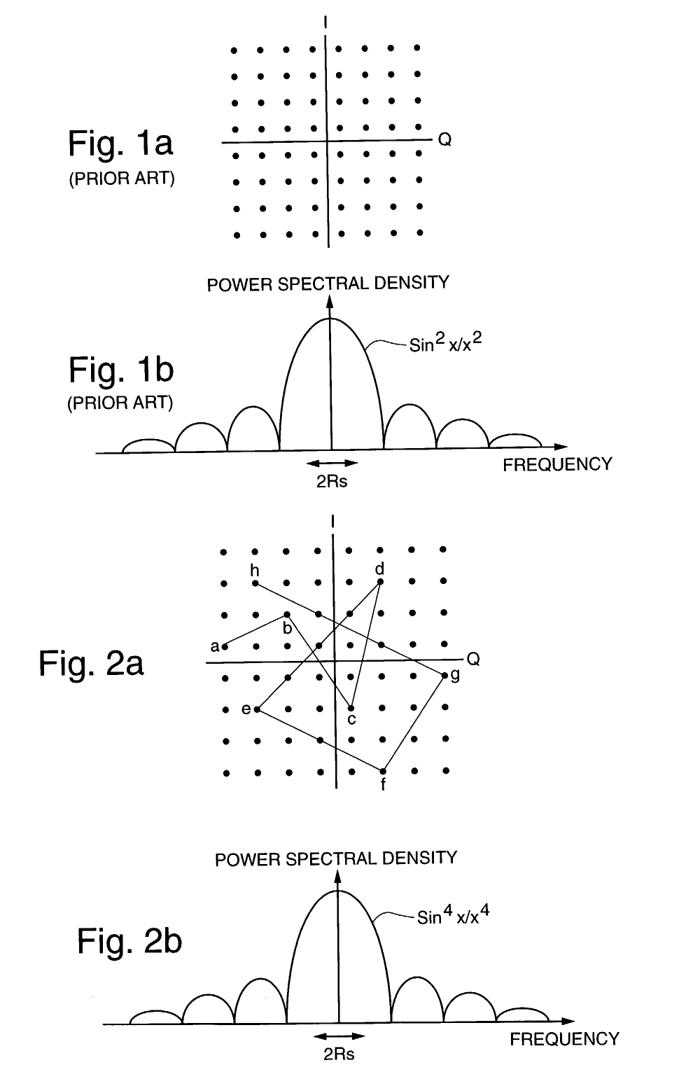

The traditional QAM waveform (see FIGS. 1a and 1b) exhibits a constant (phase-amplitude) state over the entire symbol interval. In principle, symbol transitions are made to occur in zero time and thus the theoretical spectrum is infinite in extent (obeying a Sin²(X)/X² law). The discontinuities in amplitude-phase are largely the determining factor in creating the higher order spectral artifacts.

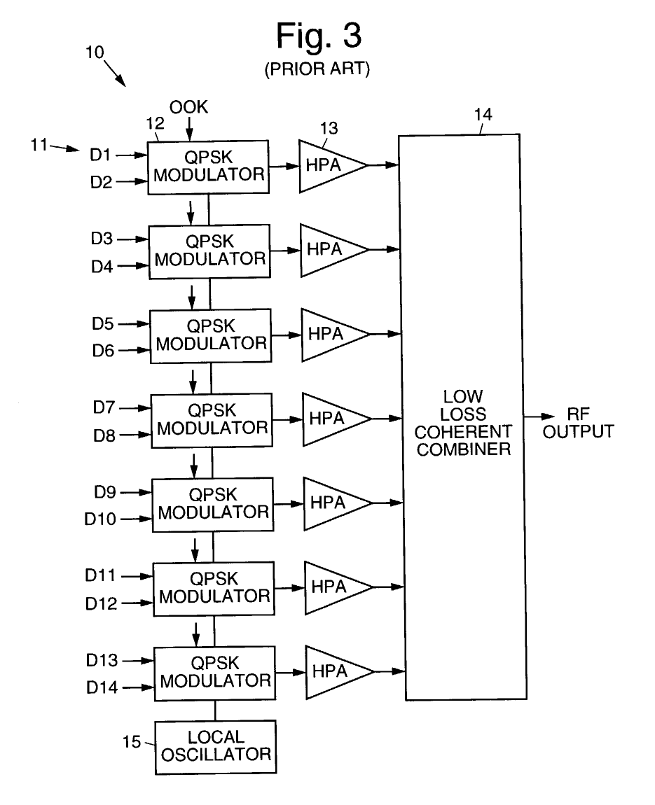

Referring again to the drawing figures, FIGS. 2a and 2b show 64MS-QAM trajectories and associated power spectrum, respectively, and illustrates minimum shift QAM (MS-QAM) in accordance with the principles of the present invention. In MS-QAM, transitions between constellation points are made to occur gradually over the entire symbol interval, as is shown in FIG. 2a.

The symbols are thus described by transitions between starting and ending points rather than the amplitude-phase states, themselves. Simple, continuous straight line amplitude-phase transitions from state to state eliminates the discontinuities but instead cause the first derivative of the transitions to be discontinuous. Consequently, spectrum obeys a more rapid than Sin²(X)/X² law rolloff and more power is concentrated close to the reference input (carrier) frequency.

The transition shapes may be made other than linear ramps and may include sectors of sinusoids and other functions that exhibit continuous higher order derivatives and more rapid higher order spectral convergence (decay in power spectral density).

Current research by the assignee of the present invention indicates that 99% of the total power may be contained within a bandwidth of twice the symbol rate and that 90% may reside within a bandpass of 1.2 times the symbol rate. The theoretical lower bound of “full response” symbol bandwidth occupancy is that bandpass equal to the symbol rate (the Nyquist bandwidth).

The present invention contemplates the use of an entire class of waveforms that extend the time required for transition between traditional QAM states to entire symbol intervals or longer. Furthermore, in accordance with the present invention, the general two-dimensionality attending MS-QAM may be extended to traditional partial response (PR) waveforms, but expressed in the amplitude-phase (or complex amplitude) domain, to achieve even higher levels of bandwidth efficiency. For partial response MS-QAM, the Nyquist bandpass bound does not apply since this is a partial response and not a full response symbol definition.

Implementation of QAM with a modulating array transmitter 10 will be discussed with reference to FIG. 3. Details of a typical modulating array transmitter is disclosed in U.S. Pat. No. 5,612,651 entitled “Modulating Array QAM Transmitter”, assigned to the assignee of the present invention, the contents of which are incorporated herein by reference in their entirety.

The modulating array transmitter 10 is a high-power, direct-conversion QAM (quadrature amplitude modulation) modulator. The modulating array transmitter 10 is comprised of a plurality of discrete, parallel stages 11, referred to as quadrature power elements (QPE) 11 or stages 11. Each quadraphase power element 11 comprises a QPSK modulator 12 and a (solid-state) high-power amplifier 13 driven to saturation.

Data bits (D1, . . . D14) are input to the plurality of quadrature power elements 11. Each quadrature power element 11 has an on/off keying (OOK) input for receiving an on/off keying bit input signal that selectively keys the modulator on and off, and a local oscillator input (LO) for receiving a reference input signal from a local oscillator 15.

The quadrature power element 11 modulates the reference input signal (or RF carrier) in accordance with the digital input signals and outputs a modulated RF excitation signal which is subsequently amplified by the high-power amplifier 13. Outputs of the quadraphase power elements 11 are combined in a power combiner 14 to build a multilevel, high-power RF output signal.

The modulating array transmitter 10 implements traditional QAM signals by vector summation of identical QPSK signal components at high power as shown in FIG. 3. These QPSK signal elements combine to form the desired QAM states when all QPSK modulation states are simultaneously switched.

However, it has been observed by the present inventors that a state change may be effected more gradually by switching each individual modulator to a new state as desired to achieve the end state of the new symbol.

For large QAM state arrays, a large number of constituent modulating array transmitter QPSK stages 11 (QPEs 11) are required and each of these may be made to transition in a time stagger that is a small portion of the symbol period. The resulting “staircasing” between QAM states constitute a stepwise approximation of a smooth transition between QAM states taking the entire symbol interval. Thus the more modulating array transmitter stages 11, the smaller the step size and the closer potential approximation to a smooth transition.

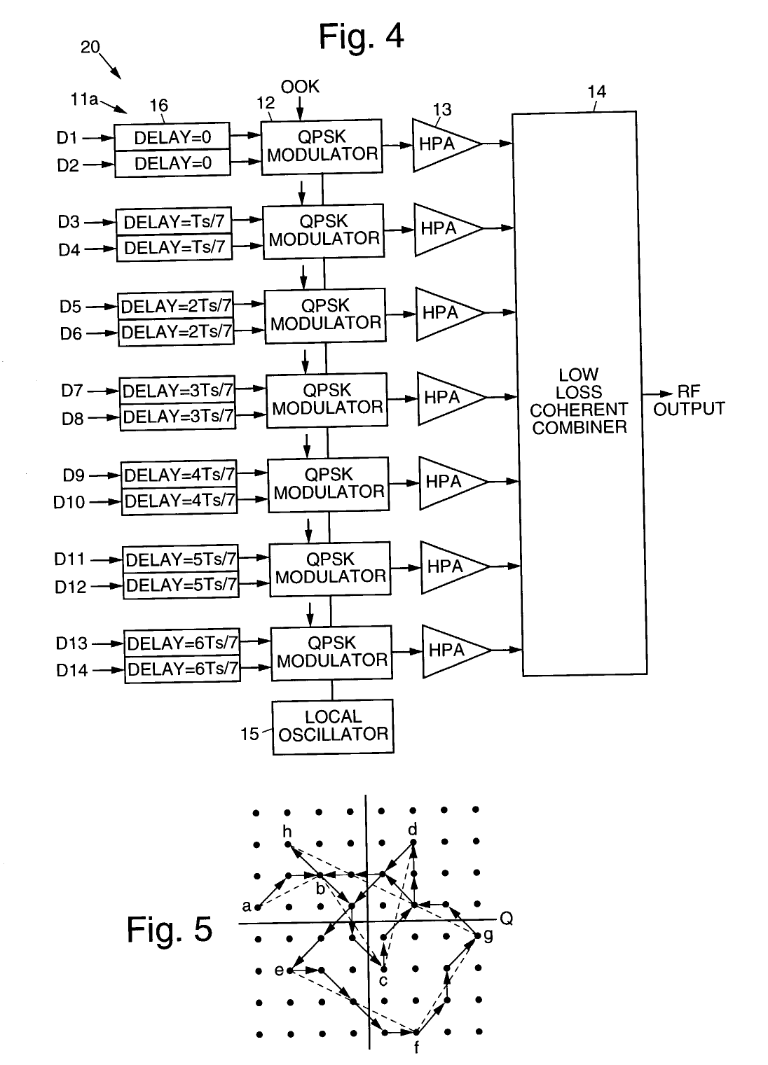

Referring now to FIG. 4, it illustrates an exemplary seven stage modulating array transmitter 20 in accordance with the principles of the present invention that implements minimum shift QAM (MS-QAM). The delaying of a transition is a simple matter of arraying binary signal delays 16 prior to modulation as shown in FIG. 4. Where K stages comprise the modulating array transmitter 20, the symbol interval may be divided into K incremental delays (of equal or non-equal duration). This is a simple modification of the basic architecture of the modulating array transmitter 10 shown in FIG. 3 to the architecture of the modulating array transmitter 20 shown in FIG. 4.

The architecture of the present modulating array transmitter 20 is substantially the same as the conventional modulating array transmitter 10 but also comprises delays 16 that delay each of the individual data bits (D1, . . . D14) prior to their processing by the respective QPSK modulators 12.

FIG. 4 illustrates that delays 16 cause stepwise incremental state changes over the full symbol interval. The array of delays 16 shown in FIG. 4 cause uniform increments over the symbol interval. There may be advantages to making these intervals non-uniform in that the bandpass spectrum may benefit therefrom.

FIG. 5 illustrates an exemplary complex signal trajectory generated by the modulating array transmitter 20 shown in FIG. 4. In FIG. 5, the solid lines show the trajectory of the I-Q (micro) state as it increments in discrete steps between the symbol states.

In particular, FIG. 5 shows the resulting complex signal trajectory as it proceeds over the example QAM states from a to h. Each of these increments represented by the solid (arrowed) lines are discrete (zero time) state changes that are only permitted to occupy the designated points of the QAM constellation. A diagonal shift comprises a discontinuous state change.

As the constellation complexity increases above 64ary, more modulating array transmitter stages 11 are required and thus the trajectories may be made to occur with smaller increments. For very large MS-QAM constellations the modulating array transmitter 20 will produce nearly ideal spectra typified in FIG. 2. Non-uniform spacing may enable more continuous derivatives at the symbol boundaries thus further suppressing the higher order spectral artifacts.

Thus, a minimum shift QAM waveform and transmitter have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A minimum shift modulated array transmitter comprising:
a local oscillator for generating a reference input signal;
a plurality of discrete, parallel QPSK power elements that each comprise:
(a) a plurality of data inputs that receive data bits;
(b) a plurality of delays that respectively delay each of the individual data bits;
(c) a QPSK modulator having an on/off keying (OOK) input for receiving an on/off keying bit input signal that selectively keys the modulator on and off, and a local oscillator input for receiving the reference input signal from the local oscillator, for modulating; and
(d) a high-power amplifier driven to saturation that is coupled to the QPSK modulator; and
a power combiner coupled to outputs of each of the QPSK power elements for combining the respective output signals therefrom to produce a multilevel, high-power RF output signal.

2. The transmitter recited in claim 1 wherein the plurality of delays cause transitions between constellation points to occur gradually over an entire symbol interval.

3. The transmitter recited in claim 1 which provides continuous phase and amplitude shifting between QAM states to suppress higher order spectral artifacts and concentrate power in a spectral region close to the frequency of the reference input signal.

4. The transmitter recited in claim 1 wherein the plurality of delays generate waveforms that extend the time required for transition between QAM states to entire symbol intervals or longer.

5. The transmitter recited in claim 1 wherein the plurality of delays cause stepwise incremental state changes over the full symbol interval.

6. The transmitter recited in claim 1 wherein individual modulators are gradually switched to a new state to achieve an end state of a new symbol.

7. The transmitter recited in claim 1 wherein symbols are described by transitions between starting and ending points rather than the amplitude-phase states.
